(19) United States
(12) Patent Application Publication
(10) Pub. No.: US 2006/0003835 A1
(43) Pub. Date: Jan. 5, 2006

(54) Gaming machine with eligibility for participation in features

(76) Inventor: Scott Olive, Lane Cove (AU)

Correspondence Address: MORRISON & FOERSTER LLP, 755 PAGE MILL RD, PALO ALTO, CA, 94304-1018, US

(21) Appl. No.: 11/203,266

(22) Filed: Aug. 12, 2005

Related U.S. Application Data
(63) Continuation of application No. 10/129,713, filed on May 6, 2002.

(30) Foreign Application Priority Data
Nov. 4, 1999 (AU) PQ3859

(51) Int. Cl. A63F 13/00

(52) U.S. Cl. 463/25; 463/13

(57) ABSTRACT

A gaming machine includes a display for displaying symbols relating to a base game. A controller, including a processor, controls operation of the base game. A controller, including a processor, controls operation of the base game and, between wagers placed on the game to determine whether the wager is to be placed in respect of the base game or the secondary event.

### CROSS-REFERENCE TO RELATED APPLICATIONS

This application is a Continuation of U.S. Ser. No. 10/129,713, filed May 6, 2002, which is a National Phase of PCT/AU00/01341, filed Nov. 2, 2000, which is a PCT Application of Australian Application PQ 3859, filed Nov. 4, 1999, the contents of which are hereby incorporated by reference into the present disclosure for all purposes as if fully put forth herein in its entirety.

### FIELD OF THE INVENTION

The present invention relates to a gaming machine of the type known as a slot machine or fruit machine. Generally, these types of machines have video simulations of rotatable reels while others are arranged to play video simulations of card games or other types of wagering games, such as bingo or keno. More particularly, the invention provides an improvement to a game played on such a machine.

### BACKGROUND TO THE INVENTION

The concept of linked progressive jackpots is becoming increasingly popular in the gaming industry where two or more gaming machines contribute portions of bets made on base games to a central jackpot pool. The pool is awarded to one or more of the contributing machines when a specified triggering event occurs. As players become used to these types of progressive jackpot arrangements, designers need to develop more exciting ways of marketing and awarding the jackpot prizes in order to stimulate existing audiences and attract new players.

As far as the applicant is aware, to be eligible for the reward of a progressive jackpot prize, the game requires that the maximum bet be staked. While this is by far the easiest way to increase total game turnover, which is beneficial to the venue housing the machines, players not playing the maximum bet are only eligible for fixed prizes as shown on a paytable of the machine. These fixed prizes are much lower than the progressive jackpot prizes and this places the player playing fewer bets at a relative disadvantage with respect to the game's return. To compound matters, while players playing fewer bets than the maximum bets still contribute to the jackpot prize pool, such players are ineligible to win the jackpot prize.

### SUMMARY OF THE INVENTION

According to a first aspect of the invention there is provided a gaming machine which includes:
a display mean for displaying at least a base game;
a control means, including a processing means, for controlling operation of at least the base game; and
a discriminating means for discriminating between wagers placed on the game to determine whether the wager is to be placed in respect of the base game or a secondary event.

The secondary event may be displayed on the display means of the gaming machine. Instead, or in addition, the secondary event may be displayed on a display means remote from the gaming machine.

Also, the secondary event may be controlled by the control means of the gaming machine or it may be controlled by a central controller with which the gaming machine is in communication.

Hence, by means of the invention, a player can choose whether or not to participate in the secondary event or feature and, if the player desires to do so, a dedicated bet needs to be made to have access to the secondary event or feature.

Preferably, the gaming machine includes an allocating means for allocating an entire wager, placed in respect of the secondary event or feature, to a prize pool for the secondary event or feature. The allocating means may operate under the control of the control means. Instead, only a portion of said entire wager may be allocated to the prize pool with the remaining part of the wager accruing to the operator of the gaming machine as the operator's profit.

The discriminating means may be activated by an actuator. The actuator may be a selector button which, conveniently, may be incorporated in a keypad on a midtrim of the machine. In addition, or instead, the actuator may be in the form of an icon on a touch screen of the gaming machine.

According to a second aspect of the invention, there is provided a gaming machine system which includes:
a gaming machine comprising a display means for displaying at least a base game, a control means, including a processing means, for controlling operation of the base game, and a discriminating means for discriminating between wagers placed on the game to determine whether the wager is to be placed in respect of the base game or a secondary event; and
a dynamic prize pool associated with the gaming machine for awarding prizes for wins in respect of the secondary event, the dynamic prize pool being related to wagers placed in respect of the secondary event.

### BRIEF DESCRIPTION OF THE DRAWINGS

The invention is now described by way of example with reference to the accompanying drawings in which:

FIG. 1 shows a three dimensional view of a gaming machine in accordance with the invention;

FIG. 2 shows a block diagram of a control circuit of the gaming machine;

FIG. 3 shows a button layout of a midtrim of the gaming machine of FIG. 1;

FIG. 4 shows a display screen with a discriminating means of the gaming machine de-activated;

FIG. 5 shows a display screen with the discriminating means of the gaming machine activated;

FIGS. 6 and 7 show display screens of a tournament feature of the gaming machine; and

FIG. 8 shows a flowchart of a game played on the gaming machine of FIG. 1.

### DETAILED DESCRIPTION OF THE DRAWINGS

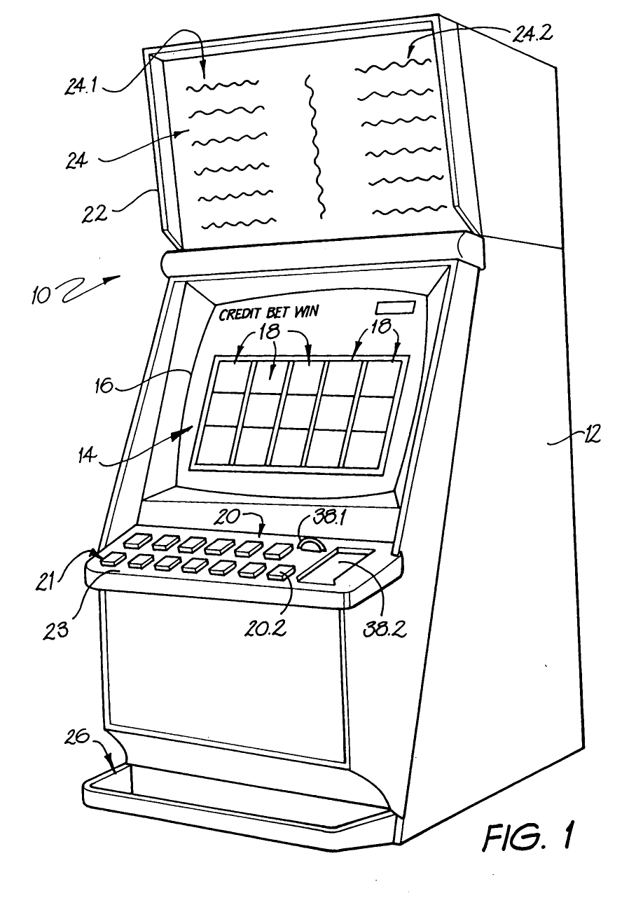

In FIG. 1, reference numeral 10 generally designates a gaming machine, including a game, in accordance with the invention. The machine 10 includes a console 12 having a video display unit 14. The video display unit 14 includes a screen 16. Video simulations of reels or reel strips 18 are simulated on the screen 16.

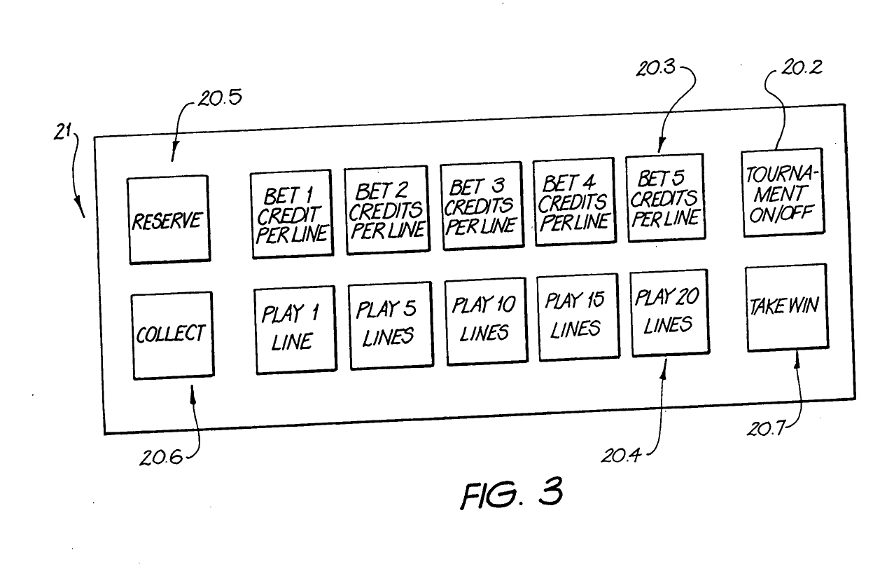

The machine 10 includes an actuator 20.2. The actuator 20.2 is a button of a keypad 21 arranged on a midtrim 23 of the console 12. A player playing the machine 10 operates one of each of the buttons 20.3 and 20.4 (FIG. 3) to be eligible to participate in a main game or base game of the machine 10. As will be described in greater detail below, the player playing the machine 10 operates the button 20.2 to be eligible to participate in a secondary event or feature.

As illustrated, the machine 10 includes a top box 22 on which a scorecard or paytable 24 is carried. The paytable 24 has two parts 24.1 and 24.2. The part 24.1 carries a paytable for the base game of the machine 10 and the part 24.2 contains progressive meters relating to the secondary event or feature.

A coin tray 26 is mounted beneath the console 12 for cash payouts from the machine 10 either as a result of a win in the base game or as a result of a win from the secondary event or feature, or both.

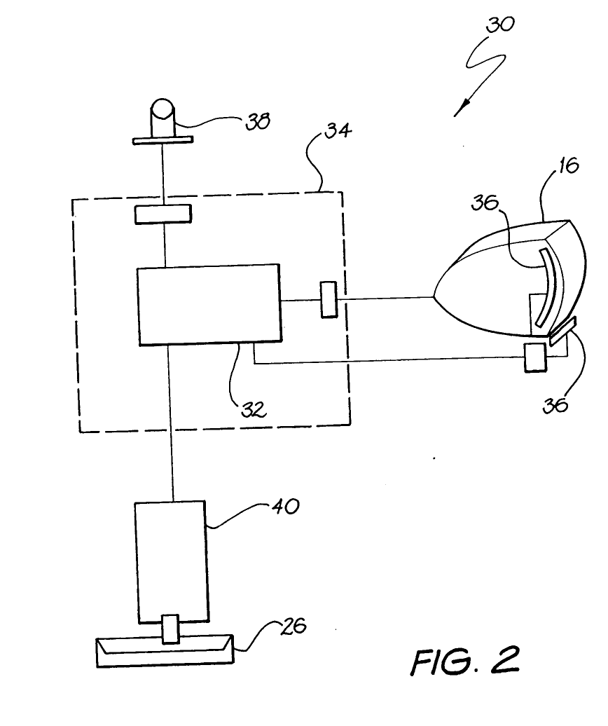

Referring to FIG. 2 of the drawings, a control system 30 is illustrated. A program which implements the game and user interface is run on a processor 32 of the control system 30. The processor 32 forms part of a controller 34 which drives the screen 16 of the video display unit and which receives input signals from sensors 36. The sensors 36 are responsive to the actuator buttons 20.1 and 20.2 and also include touch screen sensors 36 mounted in the screen 16.

The controller 34 receives input pulses from a mechanism 38 indicating that a player has provided credit to begin playing. The mechanism 38 includes a coin input chute 38.1 (FIG. 1) and a bill collector 38.2. If desired, the mechanism 38 could include instead, or in addition, a credit card reader (not shown), or any other type of validation device.

Finally, the controller 34 also drives a payout mechanism 40 which, for example, may be a coin hopper for feeding coins to the coin tray 26.

In use, the player wagers a bet via the mechanism 38. The player activates the base game of the machine 10 by operating one of each of the buttons 20.3 and 20.4.

The base game of the machine 10 is then played in the normal manner under the control of the processor 32. Any wins awarded to the player by the machine 10 are paid in the normal manner. Also, eligibility to participate in features associated with the base game, such as a free game series or second-screen animated feature, occur.

The machine 10 prompts the player, for example, via appropriate icons on the screen 16 to participate in the secondary event or feature. For the player to participate in such a secondary event or feature, a dedicated, separate bet or wager needs to be made by the player. This can be effected, once again, by applying credit to the machine via the mechanism 38. This may occur in response to prompts on the screen 16 to which the player responds via the touch screen. The secondary event may also be a spinning reel type of game. To activate the reels 18 on the screen 16 for the secondary event, the player operates the button 20.2.

When the player places a bet in respect of the secondary event, the total bet wagered in respect of the secondary event is added to a prize pool of that secondary event, game or feature. Thus, the secondary event, game or feature may have its own progressive jackpot or other bonus features associated with it.

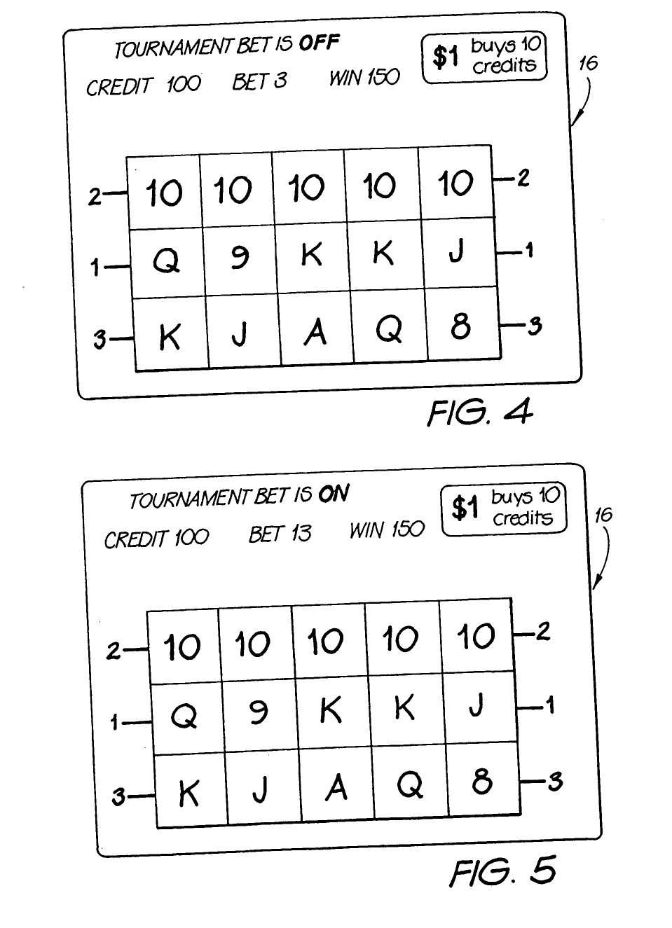

Referring to FIG. 4 a display screen of the game 16 with the button 20.2 turned off is shown. As in the case of standard spinning reel games, the player selects a number of credits per line using buttons 20.3 followed by the number of lines to play using buttons 20.4, the operation of the latter of which will also initiate the game 16. A “Reserve” button 20.5, a “Collect” button 20.6 and a “Take Win” button 20.7 all operate as standard. The button 20.2 which is labelled as a “Tournament On/Off” button serves as a toggle between the state in which the player's bet contributes only to the standard game (ie. with the button 20.2 in its “off” state) and the state in which a part of the player's bet contributes to a progressive prize or some other tournament prize (ie. with the button 20.2 in the “on” state).

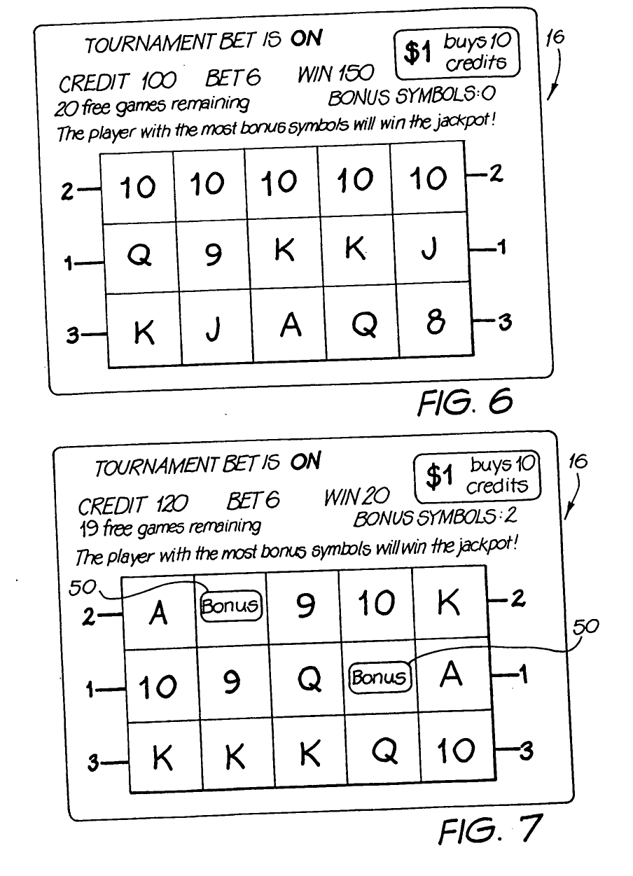

The player must switch the button 20.2 to the “on” state in order to be eligible for the tournament and a dedicated bet will be automatically taken from the player's credit meter in addition to the original bet whenever a bet is made with the button 20.2 in that state as shown in FIG. 5 of the drawings. (Note for a progressive jackpot that is not a tournament the same would apply—ie there would be a “jackpot on/off” button)
When the button 20.2 is in the “off” state, the game screen is as shown in FIG. 4 of the drawings. Games can be played in the standard way. The player will not be contributing any of his or her bet towards the tournament pool or progressive jackpot, and the player will not be eligible for the tournament feature or progressive jackpot.

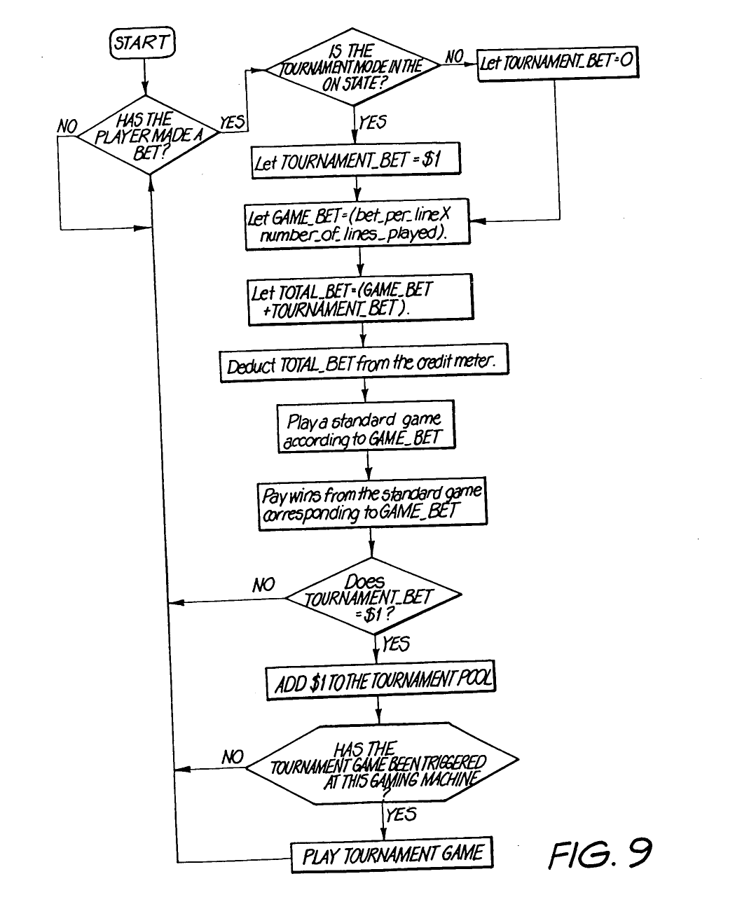

When the player toggles the button 20.2 to the “on” state, the game screen is as shown in FIG. 5 of the drawings. In the displayed example, the dedicated cost of the tournament is $1. Hence, when the player makes a bet the total cost will be 10 credits (ie $1) more than the standard bet that is placed. In this case the player is betting 1 credit per line on 3 lines plus the tournament—ie 3 credits bet on the game and 10 credits bet on the tournament feature. Hence the win for 5×10s of 150 credits will still apply as it would have if the tournament button 20.2 had not been on. The additional 10 credits will be added straight into the tournament feature pool or progressive jackpot pool stored at a tournament controller or jackpot controller 100 (FIG. 8), as the case may be, to which a number of gaming machines (those which would be eligible to participate if the tournament bet is made) are linked.

A tournament may be triggered in a number of ways. It could be from a combination on the base game of one of the gaming machines 10, a random trigger from the controller 100 (such as for a mystery jackpot) or a random trigger from one of the gaming machines 10. When the tournament controller 100 is notified of the tournament being triggered, a subset of the gaming machines 10 that are linked to the controller 100 and that are currently betting on the tournament (and therefore eligible) will be entered into the tournament or progressive jackpot feature. This may be some kind of second screen feature, or may be completely independent of the gaming machine 10 (such as a single central display or a display for the gaming machine that is independent of the gaming machine itself). It may, instead, be tied into the base game of the gaming machine 10 such as a free game series where the player who gets the most points collected over the free games will be awarded the progressive jackpot prize.

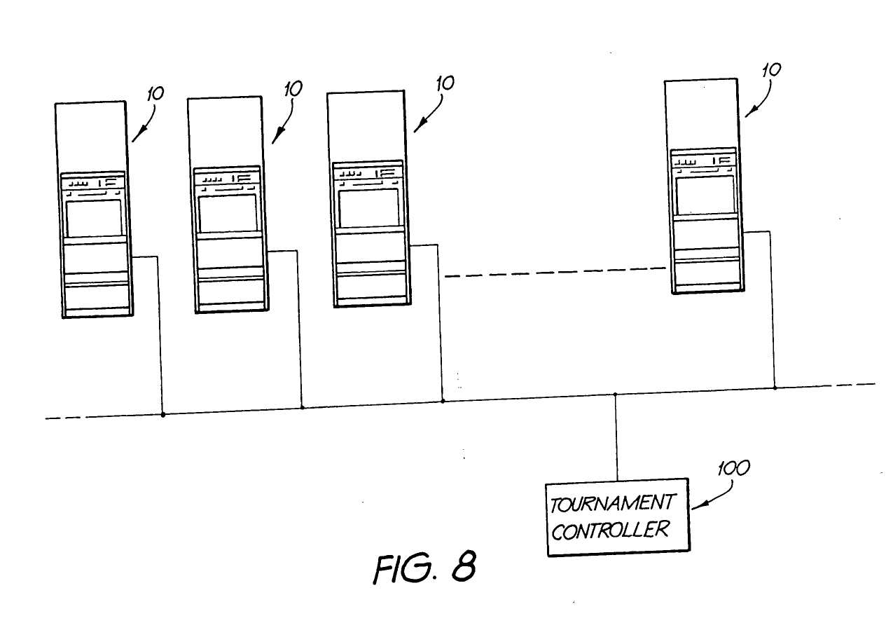

For example, as shown in FIGS. 6 and 7, a tournament may involve all eligible gaming machines playing 20 free games during which the number of bonus symbols 50 that appear on the screen of each participating gaming machine 10 will be accumulated. The player who has the most bonus symbols 50 at the end of the free games will win the jackpot prize. If more than one player gets the same number of bonus symbols 50 accumulated over their 20 free games, then the progressive prize will be distributed among those players.

It will be appreciated that a player gains eligibility to the secondary event by activating the button 20.2 and eligibility to participate in the secondary event is unrelated to participation in, or a result in respect of, the base game of the machine 10, apart from the making of a bet in respect of the base game. Thus, should a player desire to do so, access to the secondary event may be gained without necessarily having to make a maximum bet in respect of the base game.

Hence, it is an advantage of the invention that a feature is provided which enables a player to have access to a secondary event, which may also be a progressive jackpot event, without necessarily having to play the maximum stake in respect of a base game of the machine 10. Not only does this improve a player's chances of winning increased prizes, but it increases the turnover for the venue by additional bets being wagered by the players.

Another major advantage of the invention is that players who are not eligible for the secondary event do not contribute to the prize pool for the secondary event. For most existing progressive jackpot systems, players must bet the maximum bet to be eligible for the jackpot and those who do not do so still contribute a portion of their bet towards the progressive jackpot. Thus, the present invention provides a fairer system.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A gaming machine which includes:
a display means for displaying at least a base game;
a control means, including a processing means, for controlling operation of the base game; and
a player activated discriminating means for discriminating between wagers placed on a game, prior to commencement of playing of the game, to determine whether the wager is to be placed in respect of the base game or an independent secondary event, the discriminating means, when activated by the player, allocating at least a portion of the wager to the base same and at least part of a further portion of the wager to a prize pool associated with the independent secondary event.

2. The gaming machine of claim 1 in which the secondary event is displayed on the display means.

3. The gaming machine of claim 1 in which the secondary event is displayed on a display means remote from the gaming machine.

4. The gaming machine of claim 1 in which the secondary event is controlled by the control means.

5. The gaming machine of any one of claim 1 in which the secondary event is controlled by a central controller with which the gaming machine is in communication.

6. The gaming machine of claim 1 which includes an allocating means for allocating all of said further portion of the wager, to the prize pool associated with the secondary event.

7. The gaming machine of claim 6 in which the allocating means operates under the control of the control means.

8. The gaming machine of claim 1 in which the discriminating means is activated by an actuator.

9. The gaming machine of claim 8 in which the actuator is a selector button.

10. The gaming machine of claim 8 in which the actuator is in the form of an icon on a touch screen of the gaming machine.

11. A gaming machine system which includes:
a gaming machine comprising a display means for displaying at least a base game, a control means, including a processing means, for controlling operation of the base game and a player activated discriminating means for discriminating between wagers placed on a game, prior to commencement of the game, to determine whether the wager is to be placed in respect of the base game or an independent secondary event; and
a dynamic prize pool associated with the gaming machine for awarding prizes for wins in respect of the independent secondary event, the dynamic prize pool being related to wagers placed in respect of the independent secondary event, the discriminating means, when activated by the player, allocating at least a portion of the wager to the base game and a wager to the dynamic prize pool associated with the independent secondary event.

12. The system of claim 11 in which the secondary event is displayed on the display means.

13. The system of claim 11 in which the secondary event is displayed on a display means remote from the gaming machine.

14. The system of claim 11 in which the secondary event is controlled by the control means.

15. The system of claim 11 in which the secondary event is controlled by a central controller with which the gaming machine is in communication.

16. The system of claim 11 which includes an allocating means for allocating all of said further portion of the wager to the prize pool associated with the secondary event.

17. The system of claim 16 in which the allocating means operates under the control of the control means.

18. The system of claim 11 in which the discriminating means is activated by an actuator.

19. The system of claim 18 in which the actuator is a selector button.

20. The system of claim 18 in which the actuator is in the form of an icon on a touch screen of the gaming machine.
